(19) United States
(12) Patent Application Publication
(10) Pub. No.: US 2008/0168121 A1
(43) Pub. Date: Jul. 10, 2008

(54) ARRANGEMENT AND A METHOD FOR SAFE DATA COMMUNICATION VIA A NON-SAFE NETWORK

(75) Inventors: Erwin BERNECKER, Hochburg (AT); Jesef Rainer, Franking (AT); Johann Wimmer, Handenberg (AT)

Correspondence Address: GREENBLUM & BERNSTEIN, P.L.C., 1950 ROLAND CLARKE PLACE, RESTON, VA, 20191, US

(73) Assignee: BERNECKER + RAINER INDUSTRIE-ELEKTRONIK Ges.m.b.H., Eggelsberg (AT)

(21) Appl. No.: 11/970,178

(22) Filed: Jan. 7, 2008

(30) Foreign Application Priority Data
Jan. 8, 2007 (AT) A 31/2007

(51) Int. Cl. G06F 15/16

(52) U.S. Cl. 709/201

(57) ABSTRACT

In order to utilize the bandwidth available in the non-safe network for sending safe data in the best possible manner, it is provided for the safe data on the transmitter side to be combined by a network protocol-dependent transmitter optimization device in a network message or divided among several network messages and transmitted via the non-safe network. On the receiver side the safe data are extracted or combined again from the network protocol-specific data packets by a network protocol-dependent receiver optimization device.

### CROSS-REFERENCE TO RELATED APPLICATIONS

The present application claims priority under 35 U.S.C. §119 of Austrian Patent Application No. A 31/2007, filed on Jan. 8, 2007, the disclosure of which is expressly incorporated by reference herein in its entirety.

### BACKGROUND OF THE INVENTION

1. Field of the Invention

The present invention relates to an arrangement and a method for safe data communication via a non-safe network with a safe data transmitter that transmits safe data according to a safety protocol encapsulated in the network protocol via the network to a safe data receiver.

2. Discussion of Background Information

The individual components of modern automation systems communicate with one another via networks (which in this field are also often called field buses) according to certain specified (and in part standardized) protocols, such as, e.g., Ethernet, CAN, ProfiBus, Common Industrial Protocol (CIP), Ethernet Powerlink, etc. However, these networks and protocols do not ensure safe data communication, e.g., pursuant to IEC 61508 SIL 3, so that transmitted data arrive at the receiver uncorrupted or corrupted messages are recognized as such and can be corrected. Safe communication paths of this type are particularly necessary wherever defective or incorrect data could be dangerous for human health or life. Typical examples where safe data communication between a transmitter, e.g., a sensor (pressure, temperature, etc.) and a receiver, such as a control device, a valve or an actuator, are necessary, are, e.g., an emergency stop switch (sensor), which interrupts via a switch (actuator) an electric circuit or a photoelectric beam that, when triggered, switches off a machine.

In the past such safe communication paths were often wired separately and individually, which made communication via an unsafe network superfluous. However, such arrangements were expensive and complex, particularly with large automation systems, due to the wiring expenditure, which also made maintenance in particular difficult.

In recent years safe protocols have therefore also been developed for safe data communication via a network, which protocols contain corresponding error detection and error correction mechanisms known per se, such as, e.g., redundancy data, counters, data doubling, etc., which guarantee safe communication in terms of a certain standardized Safety Integration Level (SIL), such as SIL 3. The messages of the safe protocol are thereby transmitted encapsulated with a network protocol not safe per se, such as, e.g., Ethernet or CAN, via a non-safe network, such as, e.g., via a modem connection, LAN, WAN, VPN, etc. The safety mechanisms of the safe protocol that is encapsulated in the protocol of the non-safe network transmission, thereby guarantee the data integrity and data safety of the data communication. Arrangements of this type for safe data transmission via a non-safe network are described, e.g., in U.S. Pat. No. 6,891,850 B1 or WO 01/46765 A1. The methods and arrangements described therein for safe data communication are based on a 1:1 relationship between safety frame and network protocol frame, i.e., a safe message is always encapsulated in a network message. The possibilities of the network for transmitting data are thereby utilized only to a limited or unsatisfactory extent.

However, correspondingly short reaction times are also necessary in safe automation systems, since it is not constructive to be able to guarantee safe communication if this communication takes too long, so that it is no longer possible to react promptly to certain events. The transmission times of data in the network must therefore be reliably short, e.g., in the range of a few hundred μs, as with Ethernet Powerlink. With safe data communication the situation is further intensified, since a safe protocol is encapsulated in a non-safe protocol and the bandwidth of the network available for the safe payloads is reduced by the overhead of the data encapsulation. It is all the more important here to achieve and above all also to ensure short transmission times via the network. Furthermore, each network also has a natural bandwidth that determines the transmittable amount of data per time unit and thus likewise represents a limitation of the transmission speed. However, this bandwidth cannot be used arbitrarily: each protocol specifies a data packet (a message) with a specific number of payloads and a number of protocol-specific data (such as, e.g., header, frame termination, status data, diagnosis data, CRC, counter, etc.). However, the known safe data communication systems do not take this into account, so that the (theoretically) available bandwidth is not optimally utilized, which can reduce the transmission times of data. This problem is becoming increasingly serious, however, with the constantly growing automation systems with increasingly large numbers of safe and non-safe I/O units (such as actuators, sensors) and control units, which communicate with one another via the same non-safe network, since the number of data packets running via the network is thus constantly growing and the data transmission bandwidth is correspondingly utilized.

### SUMMARY OF THE INVENTION

Therefore, the present invention optimally utilizes the data transmission bandwidth available in the network for safe data communication via the network and to guarantee short transmission times of safe data.

According to the invention, a network protocol-dependent transmitter optimization device connected to the network is provided on the transmitter side, which device receives the safe data from the safe data transmitter and, independent of the safety protocol, subdivides or combines them on network protocol-specific data packets of specific predetermined payload lengths and transmits the network protocol-specific data packets via the non-safe network, and in that a network protocol-dependent receiver optimization device connected to the network is provided on the receiver side, which device extracts or assembles the safe data from the network protocol-specific data packets and forwards said data to the safe data receiver. This ensures that a device that knows about the implemented network protocol optimally converts the safe data into data packets that can be transmitted via the network with the best possible utilization of the available bandwidth. The safety protocol on which the safe data are based is not affected thereby, but is transmitted encapsulated in the network protocol. The high safety required can thus be ensured with optimal utilization of the network bandwidth, which also ensures that the transmission times of the safe messages are reliably as short as possible according to the network protocol. A 1:n or n:1 relation between safety frame and network protocol frame can thus also be realized, which also increases the flexibility of the data transmission.

Advantageously the transmitter optimization device is arranged integrated in the data transmitter and/or the receiver optimization device is arranged integrated in the data receiver, although of course one unit in the arrangement can be data transmitter as well as data receiver, and thus both devices can be contained in the unit.

If a number of data transmitters and or data receivers are connected via a data bus to a transmission optimization device and/or a receiver optimization device, it is possible to provide only one transmission optimization device and/or one receiver optimization device for a plurality of transmitters or receivers, which reduces the expenditure for the individual transmitter or receiver. Only one unit (the network connection unit with the transmission optimization device and/or the receiver optimization device) therefore now needs to know about the implemented network protocol, whereas the individual transmitters or receivers are all embodied with a specified data bus protocol (which can be a protocol independent of the network) and consequently are uniform.

The available bandwidth of the network protocol can be still better utilized if the transmitter optimization device also inserts non-safe data into a network protocol-specific data packet, since one is thus even more flexible in the production of the data packets.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows an arrangement for safe data communication via a non-safe network;

FIG. 2 shows another arrangement according to the invention;

FIG. 3 shows yet another arrangement according to the invention;

FIG. 4 shows in diagrammatic form the data transport via the network; and

FIG. 5 shows another example of data transport via the network.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

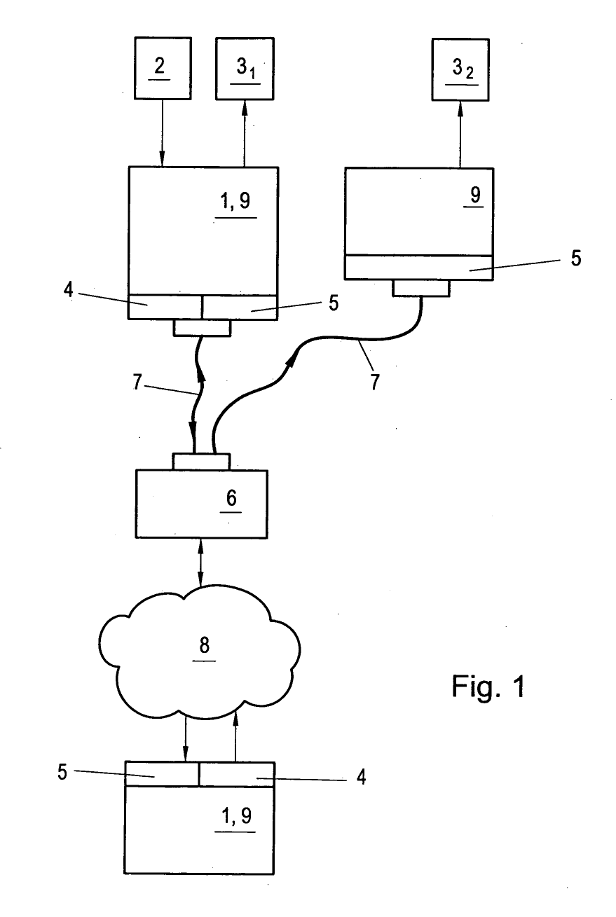

FIG. 1 shows represented very diagrammatically an arrangement for safe data communication from a safe data transmitter 1 to a safe data receiver 9 via a non-safe network 8. The safe data transmitter 1, here, for example, an I/O unit, can receive via a safe input safe signals from a sensor 2, e.g., an emergency stop switch, a photoelectric beam, a speed or position sensor of an engine control system, etc., and transmit safe signals via a safe output to a safe actuator 3, such as, e.g., a switch, an engine timing system, etc. An I/O unit of this type generally has several safe input and output channels, so that a number of sensors 2 and actuators 3 can be switched on. However, of course it is also conceivable for an I/O unit to have only one safe input or output or for a number of non-safe inputs or outputs to also be available in addition to safe inputs or outputs on the I/O unit.

The data received from a safe input of an I/O unit should be transmitted via a network 8 to a safe data receiver 9, e.g., a safe control device. The signals received can, of course, thereby be further processed, e.g., conditioned, digitalized, filtered, etc., in the I/O unit 1 as required. The data are thereby transmitted via the non-safe network, e.g., Ethernet, LAN, WAN, VPN, modem connection, etc., with any non-safe data communication protocol, such as, e.g., TCP/IP, CAN, ProfiBus, Ethernet Powerlink. A data packet with a certain number of payloads and other data is specified for each of these data communication protocols. A certain available bandwidth results therefrom for the data transmission together with the electrical specifications of the data communication protocol. The data packet sizes thereby vary between a few bytes and a few kilobytes.

Depending on the length of a safe datum, a non-safe data packet of this type would now be more or less well utilized during transmission of the safe datum, depending on how many of the available payloads are required by the safe datum. In particular with combinations such as very short safe data (e.g., a few bytes) with a data communication protocol with data packets with very long payload lengths (e.g., a few kilobytes), the bandwidth of the data communication protocol theoretically available is only very poorly utilized.

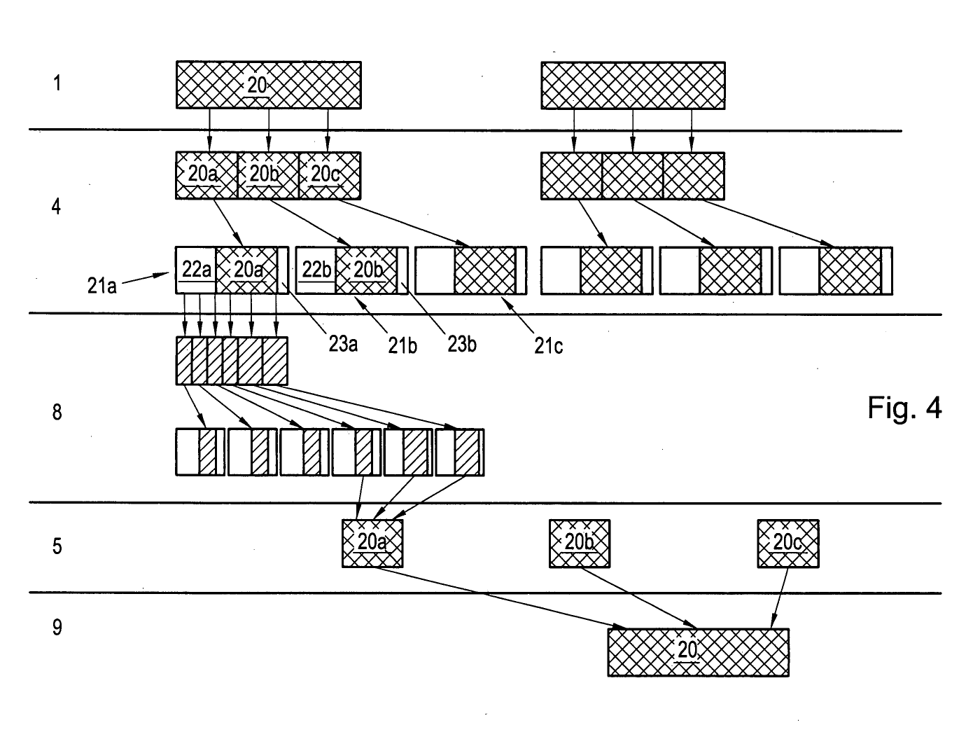

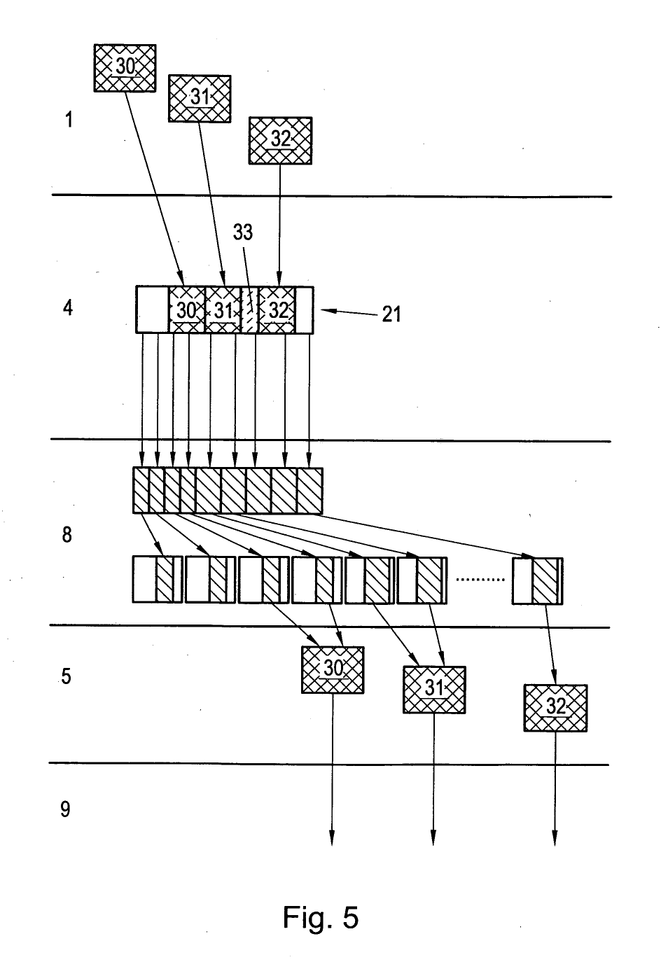

In order to utilize the available bandwidth of a given data communication protocol via the network 8 (network protocol) as well as possible, a transmitter optimization unit 4 is now provided on the transmitter side. In this exemplary embodiment this transmitter optimization unit 4 is integrated into the I/O unit 1 and connected to the network 8, e.g., via a conventional network cable 7. The transmitter optimization unit 4 knows the specific data packet structure of the network protocol used, e.g., TCP/IP, and is thus network protocol-dependent. The transmitter optimization unit 4 is thus able to utilize in the best possible manner the available data packet length of the specified network protocol. To this end the individual safe data to be transmitted are combined in a data packet or a safe datum is distributed among several data packets, as described in detail below based on FIGS. 4 and 5.

The data are transmitted via the network 8 to the safe data receiver 9. To this end a receiver optimization device 5 is provided on the receiver side, e.g., as in this exemplary embodiment, integrated in the data receiver 9. The receiver optimization device 5 extracts the safe data from data packets specific to the network or combines them again accordingly, as described in detail below based on FIGS. 4 and 5. The data receiver 9, e.g., a safe control device, can now process accordingly the safe data received and transmit them to another unit. The data receiver 9 thus becomes a data transmitter, as described above.

A unit in the arrangement for data communication is thus as a rule data transmitter 1 and data receiver 9 simultaneously. However, purely data transmitters 1 or purely data receivers 9 (as indicated in FIG. 1) are also conceivable.

For example, a sensor 2, such as an emergency stop switch, could send a switching status with the I/O unit, which is acting as safe data transmitter 1, via the network 8 to a safe data receiver 9, such as a safe control device. The received signal (switching status) can be processed there and a corresponding reaction set. To this end corresponding data can be transmitted from the control device, which is now acting as data transmitter 1, in turn via the network 8 and I/O units, which are now acting as data receiver 9, to a number of actuators 31, 32, e.g., switches that break certain electric circuits.

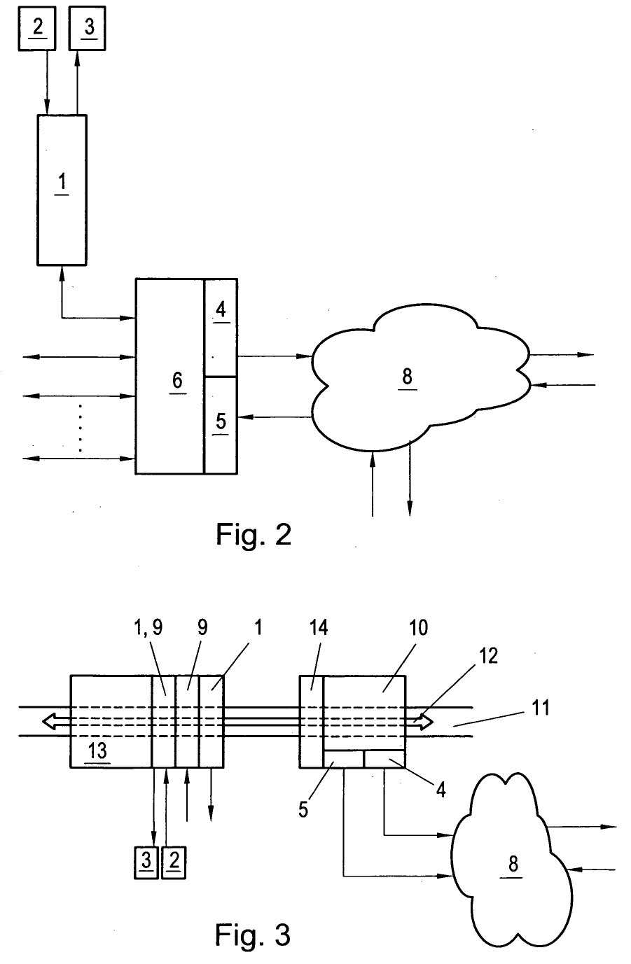

Moreover, an adequately known network connection unit, such as, e.g., a router 6, can be provided on the transmitter and/or receiver side. In this case the safe data transmitter 1 and/or the safe data receiver 9 would not be connected to the network 8 directly, but via the network connecting unit. Likewise, it would be possible in this example for the transmitter optimization unit 4 and/or the receiver optimization unit 5 to be integrated into the network connecting unit, and for the data transmitter 1 and/or the data receiver 9 consequently not to require their own transmitter optimization unit 4 and/or receiver optimization unit 5, as shown in diagrammatic form in FIG. 2 based on a router 6.

FIG. 3 describes another possible arrangement for safe data communication over a non-safe network 8. In this example a backplane 11 is provided on which a number of units are arranged next to one another. A number of safe data transmitters 1 and safe data receivers 9 are arranged on the backplane 11 as well as combined transmitter/receiver units, such as, e.g., safe I/O units, control devices, etc. A number of non-safe data transmitters and/or receivers 14 could likewise be arranged on the backplane 11. The safe data transmitters/receivers 1, 9 and optionally the non-safe data transmitters/receivers 14 are connected to one another and to a network connection unit 10 via a (serial or parallel) data bus 12. The safe data transmitters/receivers 1, 9 and optionally the non-safe data transmitters/receivers 14 communicate via this data bus 12 with one another and with the network connection unit 10 with a selected bus protocol, such as, e.g., CAN, TCP/IP, etc., and the bus protocol can be different from the network protocol 8. The network connection unit 10 is connected via a transmitter optimization unit 4 and/or a receiver optimization unit 5 directly or indirectly via a network connection unit to the network 8. If a data transmitter 1 wants to transmit data via the network 8, it first sends the data via the data bus 12 with the bus protocol to the network connection unit 10, which receives the data and sends them via the transmitter optimization unit 4 with the best possible utilization of the network protocol bandwidth via the network 8. The reception of data takes place conversely in a corresponding manner. With an arrangement of this type it could also be provided that the safe data transmitters/receivers 1, 9 arranged next to one another and optionally the non-safe data transmitters/receivers 14 communicate directly with one another via the bus protocol and the detour via the network 8 is not taken, which in turn would take up network bandwidth. The units on the backplane 11 could thereby also be supplied with power by a central energy supply unit 13, which can also be arranged on the backplane 11.

FIGS. 4 and 5 show how a transmitter optimization unit 4 and a receiver optimization unit 5 can work. In addition to the actual payloads, e.g., a switch position, an engine speed, etc., a safe datum 20, 30 also contains a number of other data, such as, e.g., the necessary safety mechanisms (CRC, doubled payloads, counters, time references, etc.), headers, termination data, status data, etc., according to the specifications of the implemented safety protocol.

According to FIG. 4, a safe datum 20, which a safe data transmitter 1 can have received, e.g., from a sensor 2, and which was too long to be able to be transmitted in the payload of a network message, is divided up by the transmitter optimization device 4 among a number (in this case, 3) of smaller data segments 20a, 20b, 20c, so that data packets 21 are produced which optimally utilize the available payload length of the network protocol. Due to the network protocol-dependent overhead 22, 23 of the data packets 21 of the data to be transmitted, e.g., by header, termination data, counters, status data, CRC, etc., it is advantageous for the utilization of the bandwidth if the length of the payloads is correspondingly longer than the number of the overhead bytes. The datum 20 to be transmitted can, for example, be divided evenly among several data segments 20a, 20b, 20c, or it could be provided for as many data packets 21 as possible to be generated with maximum utilization of the payloads. The transmitter optimization device 4 thus generates from the data segments 20a, 20b, 20c data packets 21a, 21b, 21c with the network protocol-specific overhead 22a, 23a, 22b, 23b, which are transmitted to the network 8 for forwarding to the data receiver 9. The network 8 can transfer the data packets 21 independently according to any diagram (e.g., the data packets are sent differently via a modem line from via the Ethernet) as indicated in FIG. 4. Of course, it is also conceivable for different types of network (e.g., Ethernet, modem, etc.) to be interconnected to form a network 8 so that the data packets 21 are reformatted several times within the network 8, which, however, is not discernible or significant outwardly (thus for the transmitter optimization device 4 or the receiver optimization device 5). How the data packets 21 are transmitted within the network 8 cannot be influenced and is not important either for the present invention.

The receiver optimization device 5 receives from the network 8 the individual data packets 21a, 21b, 21c and removes the overhead 22a, 23a, 22b in order to obtain the data segments 20a, 20b, 20c, which subsequently are reassembled to form the transmitted datum 20.

In the example according to FIG. 5, several safe data 30, 31, 32, which are received, e.g., from several sensors 2 of the same or different I/O unit(s), are combined into a data packet 21 in the transmitter optimization device 4. The data packet 21 can also contain non-safe data 33 in addition to the safe data 30, 31, 32. An approach of this type is particularly advantageous when the lengths of the safe data 30, 31, 32 is short relative to the reliable network protocol-dependent length of the payloads in the data packet 21, and consequently several such safe data 30, 31, 32 can be transmitted in a data packet 21. On the receiver side the safe data 30, 31, 32 are extracted again from the data packet 21 received in the receiver optimization device 5 and forwarded to the data receiver 9.

Depending on the application of the data communication, of course a combination of the two methods described above is also possible. Since the transmitter optimization device 4 or the receiver optimization device 5 must know about the switched network protocol, an optimized utilization of this type of the bandwidth of the data packets of the network protocol can be easily realized.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. Arrangement for safe data communication via a non-safe network with a safe data transmitter that transmits safe data according to a safety protocol encapsulated in the network protocol via the network to a safe data receiver, wherein a network protocol-dependent transmitter optimization device connected to the network is provided on the transmitter side, which device receives the safe data from the safe data transmitter and, independent of the safety protocol, subdivides or combines them on network protocol-specific data packets of specific predetermined payload lengths and transmits the network protocol-specific data packets via the non-safe network, and in that a network protocol-dependent receiver optimization device connected to the network is provided on the receiver side, which device extracts or assembles the safe data from the network protocol-specific data packets and forwards these data to the safe data receiver.

2. Arrangement according to claim 1, wherein the transmitter optimization device is arranged integrated in the data transmitter and/or the receiver optimization device is arranged integrated in the data receiver.

3. Arrangement according to claim 1, wherein a network connection unit is provided on the transmitter side and/or on the receiver side and the transmitter optimization device is arranged integrated in the transmitter-side network connection unit and/or the receiver optimization device is arranged integrated in the receiver-side network connection unit.

4. Arrangement according to claim 1, wherein a plurality of data transmitters and data receivers are provided which communicate with one another via the network.

5. Arrangement according to claim 1, wherein a number of data transmitters and/or data receivers are connected via a data bus to a transmitter optimization device and/or a receiver optimization device.

6. Arrangement according to claim 5, wherein the data transmitters, data receivers, transmitter optimization device and/or receiver optimization device communicate with one another via the data bus via a protocol independent of the network.

7. Arrangement according to claim 1, wherein the transmitter optimization device also inserts non-safe data into a network protocol-specific data packet.

8. Method for transmitting safe data via a non-safe network in which safe data are transmitted according to a safety protocol encapsulated in the network protocol via the network by a safe data transmitter to a safe data receiver, wherein on the transmitter side the safe data are received by the safe data transmitter and divided up or combined on network-specific data packets of specific predetermined payload lengths in a network protocol-dependent transmitter optimization device connected to the network independent of the safety protocol, and the data packets are transmitted via the non-safe network and that on the receiver side the safe data are extracted or combined from the network protocol-specific data packets received in a network protocol-dependent receiver optimization device connected to the network and are forwarded to the safe data receiver.

9. Method according to claim 8, wherein a number of data transmitters and/or data receivers are connected via a data bus to a transmitter optimization device and/or a receiver optimization device.

10. Method according to claim 9, wherein the data transmitters, data receivers, transmitter optimization device and/or receiver optimization device (4) communicate with one another via the data bus via a protocol independent of the network.

11. Arrangement according to claim 8, wherein the transmitter optimization device also inserts non-safe data into a network protocol-specific data packet.
